(19) United States
(12) Patent Application Publication
(10) Pub. No.: US 2009/0021373 A1
(43) Pub. Date: Jan. 22, 2009

(54) DOOR LOCK SYSTEM HAVING STATE FEEDBACK AND METHOD FOR CONTROLLING THE STATE OF THE SAME

(75) Inventors: YANHUA CHEN, SHENZHEN (CN); JIANWEI LIU, SHENZHEN (CN); XIAOYONG DONG, SHENZHEN (CN)

Correspondence Address: ROSENBERG, KLEIN & LEE, 3458 ELLICOTT CENTER DRIVE-SUITE 101, ELLICOTT CITY, MD, 21043, US

(73) Assignee: SHENZHEN H&T INTELLIGENT CONTROL CO., LTD., SHENZHEN (CN)

(21) Appl. No.: 12/119,533

(22) Filed: May 13, 2008

(30) Foreign Application Priority Data
Jul. 17, 2007 (CN) 200710076022.6

(51) Int. Cl. E05B 45/06

(52) U.S. Cl. 340/542

(57) ABSTRACT

A door lock system having state feedback comprises a door lock; a control circuit for controlling the unlocking or locking of the door lock; a feedback circuit for detecting the state of the door lock; a central processing unit for reading the state of the door lock outputted from the feedback circuit and controlling the control circuit to unlock or lock the door lock. In the door lock system, the electromagnetic valve is used instead of mechanical switch, which lowers the failure rate of the door lock and improves the reliability of the door lock, and the feedback circuit is capable of detecting the state of door lock, and therefore a feedback signal can be provided in time when the door lock is failed, which ensures the efficient control of the door lock.

### BACKGROUND OF THE INVENTION

The present invention relates to a door lock circuit, in particular to a door lock system having state feedback.

Typically, known door lock systems are realized by mechanical switch, which is of high failure rate, low reliability, etc.

### SUMMARY OF THE INVENTION

Having outlined the state of the prior art and its attendant shortcomings, it is an objective of the present invention to provide a door lock system having state feedback.

To achieve the above objective, the present invention provides a door lock system having state feedback which includes a door lock, a control circuit for controlling the unlocking or locking of the door lock, a feedback circuit for detecting the state of the door lock, a central processing unit for reading the state of the door lock outputted from the feedback circuit and controlling the control circuit to unlock or lock the door lock.

Preferably, the control circuit comprises an electromagnetic valve for carrying out the unlocking or locking of the door lock, and a drive circuit for driving the electromagnetic valve.

Preferably, the feedback circuit comprises a signal stabilizing device for stabilizing the feedback signal of the door lock during the unlocking or locking of the door lock.

Preferably, the central processing unit is a Micro Controller Unit.

Preferably, the signal stabilizing device is a capacitor.

It is another objective of the present invention to provide a method for controlling the state of a door lock system. The method comprises: controlling the unlocking or locking of the door lock by a control circuit; detecting the state of the door lock by a feedback circuit; reading the state of the door lock outputted from the feedback circuit by a central processing unit; controlling the control circuit to unlock or lock the door lock by the central processing unit; wherein, A1) the door lock is set into a given state by the central processing unit via the control circuit; A2) the central processing unit detects whether the door lock is in the given state via the feedback circuit, and if the door lock is in the given state, the detecting is over; if the door lock is not in the given state, return to step A1).

The given state may be an unlocked state.

Alternatively, the given state is a locked state.

Preferably, the step A1) further comprises the following step: A11) the central processing unit clears the operation times.

Preferably, the step A2) further comprises the following step: A21) if the central processing unit is not in the given state, the operation times add one; and then if the operation times do not exceed the maximum retry times, return to step A1); and if the operation times exceed the maximum retry times, the central processing unit reminds the user to check the door lock according to the feedback signal reporting an error.

The door lock system of the present invention provides the following advantages: the electromagnetic valve is used instead of mechanical switch, which lowers the failure rate of the door lock and improves the reliability of the door lock, and the feedback circuit is capable of detecting the state of door lock, and therefore a feedback signal can be provided in time when the door lock is failed, which ensures the efficient control of the door lock.

### BRIEF DESCRIPTION OF THE DRAWINGS

FIG. 1 is a block diagram of a door lock system having state feedback according to a preferred embodiment of the present invention.

FIG. 2 is a circuit diagram of a door lock system having state feedback according to a preferred embodiment of the present invention.

### DETAILED DESCRIPTION OF THE INVENTION

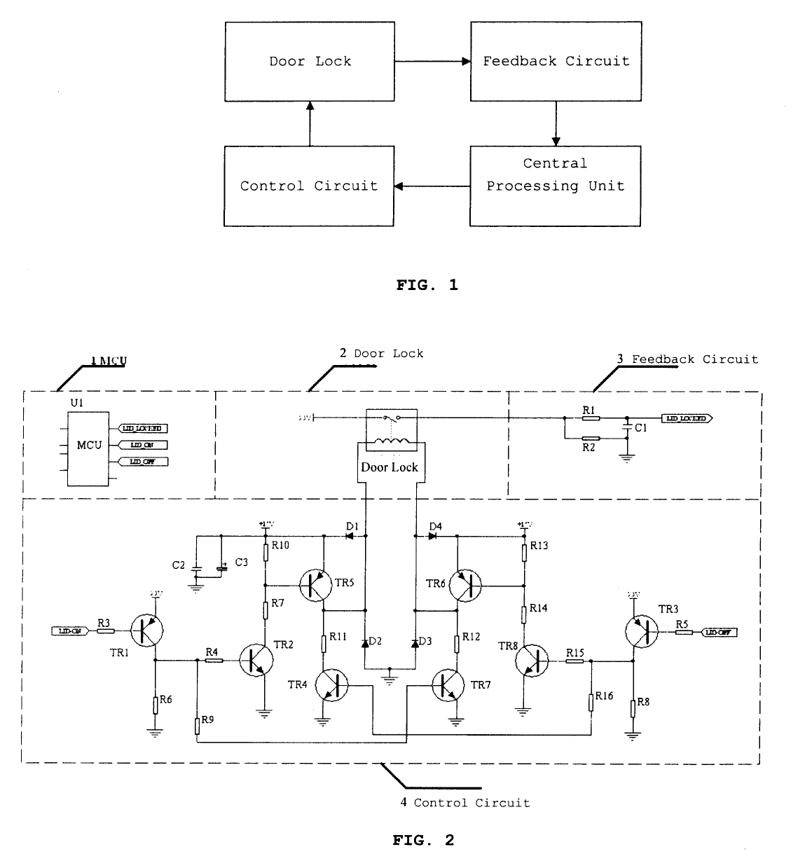

Referring to FIG. 1, a door lock system having state feedback is shown in block diagram. The door lock system comprises a door lock, a control circuit for controlling the unlocking or locking of the door lock, a feedback circuit for detecting the state of the door lock, a central processing unit for reading the state of the door lock outputted from the feedback circuit and controlling the control circuit to unlock or lock the door lock.

FIG. 2 illustrates a circuit diagram of a door lock system having state feedback. As shown in FIG. 2, the door lock is controlled by electromagnetic valve which in turn is controlled by the control circuit. A MCU is used as the central processing unit. The feedback circuit consists of R1, R2 and C1, and feeds back the door lock state to the MCU. In the control circuit, R3, R6, TR1, R5, R8 and TR3 form a pre-driver circuit; C3 and C2 are filter capacitors; D1, D2, D3 and D4 are clamping diodes for preventing the back EMF generated with the closure of the electromagnetic valve from destroying the triodes. The LID OFF is for controlling the locking of the door lock, and the LID ON is for controlling the unlocking of the door lock. The controlling process will be described in detail in the following text.

When the door is to be locked, a low level signal is outputted from the LID OFF I/O port of the MCU, and inputted into TR3 to output a high level signal. The high level signal is transmitted out via two routes, one of which conducts TR8 and TR6 and connects a voltage of 15V to one end of the electromagnetic valve, and the other one of which conducts TR4 and connects the electromagnetic valve with the GND, in this way, the electromagnetic valve carries out the locking operation of the door. Once the door is locked, the internal switch associating with the door is closed, and a high level signal is fed back to the MCU by the detecting circuit. After the door is locked, even if the control signal is removed, the door remains in the locked state, and only when a signal for unlocking the door is presented, the unlocking operation of door is to proceed.

When the door is to be unlocked, a low level signal is outputted from the LID ON I/O port of the MCU, and inputted into TR1 to output a high level signal. The high level signal is transmitted out via two routes, one of which conducts TR2 and TR5 and connects a voltage of 15V to one end of the electromagnetic valve, and the other one of which conducts TR7 and connects the electromagnetic valve with the GND, in this way, the electromagnetic valve carries out the unlocking operation of the door. Once the door is unlocked, the internal switch associating with the door is disconnected, and a low level signal is fed back to the MCU by the detecting circuit. After the door is unlocked, even if the control signal is removed, the door remains in this state, and only when a signal for locking the door is presented, the locking operation of door is to proceed.

What is claimed is:

1. A door lock system having state feedback comprising:
a door lock;
a control circuit for controlling the unlocking or locking of the door lock;
a feedback circuit for detecting the state of the door lock;
a central processing unit for reading the state of the door lock outputted from the feedback circuit and controlling the control circuit to unlock or lock the door lock.

2. The door lock system of claim 1, wherein the control circuit comprises an electromagnetic valve for carrying out the unlocking or locking of the door lock, and a drive circuit for driving the electromagnetic valve.

3. The door lock system of claim 1, wherein the feedback circuit comprises a signal stabilizing device for stabilizing the feedback signal of the door lock during the unlocking or locking of the door lock.

4. The door lock system of claim 1, wherein the central processing unit is a Micro Controller Unit.

5. The door lock system of claim 3, wherein the signal stabilizing device is a capacitor.

6. A method for controlling the state of a door lock system comprising:
controlling the unlocking or locking of the door lock by a control circuit;
detecting the state of the door lock by a feedback circuit;
reading the state of the door lock outputted from the feedback circuit by a central processing unit;
controlling the control circuit to unlock or lock the door lock by the central processing unit;
wherein:
A1) the door lock is set into a given state by the central processing unit via the control circuit;
A2) the central processing unit detects whether the door lock is in the given state via the feedback circuit, and if the door lock is in the given state, the detecting is over; if the door lock is not in the given state, return to step A1).

7. The method of claim 6, wherein the given state is an unlocked state.

8. The method of claim 6, wherein the given state is a locked state.

9. The method of claim 6, wherein the step A1) further comprises the following step:
A11) the central processing unit clears the operation times.

10. The method of claim 9, wherein the step A2) further comprises the following step:
A21) if the central processing unit is not in the given state, the operation times add one; and then if the operation times do not exceed the maximum retry times, return to step A1); and if the operation times exceed the maximum retry times, the central processing unit reminds the user to check the door lock according to the feedback signal reporting an error.
